(19) United States
(12) Patent Application Publication
(10) Pub. No.: US 2011/0091069 A1
(43) Pub. Date: Apr. 21, 2011

(54) INFORMATION PROCESSING APPARATUS AND METHOD, AND COMPUTER-READABLE STORAGE MEDIUM

(75) Inventors: Mahoro Anabuki, Yokohama-shi (JP); Atsushi Nogami, Tokyo (JP)

(73) Assignee: CANON KABUSHIKI KAISHA, Tokyo (JP)

(21) Appl. No.: 12/877,479

(22) Filed: Sep. 8, 2010

(30) Foreign Application Priority Data
Oct. 20, 2009 (JP) 2009-241879

(51) Int. Cl. G06K 9/00

(52) U.S. Cl. 382/103

(57) ABSTRACT

An information processing apparatus comprises: an extraction unit configured to extract a person from a video obtained by capturing a real space; a holding unit configured to hold a movement estimation rule corresponding to a partial region specified in the video; a determination unit configured to determine whether a region where the person has disappeared from the video or appeared in the video corresponds to the partial region; and an estimation unit configured to estimate, based on the movement estimation rule corresponding to the partial region determined to correspond, a movement of the person after the person has disappeared from the video or before the person has appeared in the video.

### BACKGROUND OF THE INVENTION

1. Field of the Invention

The present invention relates to an information processing apparatus and method and a computer-readable storage medium.

2. Description of the Related Art

For example, there are known several techniques aiming at recording movements of persons in a common home environment as video and audio data, automatically extracting a movement pattern significant for a person from the recorded movement group, and representing it to the person. Michael Fleischman, Philip DeCamp, and Deb Roy, “Mining Temporal Patterns of Movement for Video Event Recognition”, Proceedings of the 8th ACM SIGMM International Workshop on Multimedia Information Retrieval (2006) discloses a technique aiming at recording resident's movements in an ordinary household using cameras and microphones attached to the ceiling of each room, and semi-automatically annotating the movements.

“Interactive Experience Retrieval for a Ubiquitous Home”, ACM Multimedia Workshop on Continuous Archival of Personal Experience 2006 (CARPE2006), pp. 45-49, Oct. 27, 2006, Santa Barbara, Calif. discloses a technique of recording living movements of persons in a household using a number of pressure sensors installed in floors and cameras and microphones on the ceilings, summarizing/browsing recorded videos based on the position of each person, and detecting interactions between persons or between pieces of furniture and persons. Note that not only the above-described techniques but also an enormous number of other techniques aiming at recording all movements in a home environment and extracting significant information have been under researches.

Many of these techniques assume installing a number of sensor devices such as cameras and microphones throughout the house, resulting in high cost. For example, the costs of single devices are high, as a matter of course. Even if the single devices are inexpensive, and the number of devices is small, creating the environment in an existing house or the like requires a considerable installation cost.

### SUMMARY OF THE INVENTION

The present invention provides a technique of estimating the movement of a person in an uncaptured region.

According to a first aspect of the present invention there is provided an information processing apparatus comprising: an extraction unit configured to extract a person from a video obtained by capturing a real space; a holding unit configured to hold a movement estimation rule corresponding to a partial region specified in the video; a determination unit configured to determine whether a region where the person has disappeared from the video or appeared in the video corresponds to the partial region; and an estimation unit configured to estimate, based on the movement estimation rule corresponding to the partial region determined to correspond, a movement of the person after the person has disappeared from the video or before the person has appeared in the video.

According to a second aspect of the present invention there is provided a processing method to be performed by an information processing apparatus, comprising: extracting a person from a video obtained by capturing a real space; based on information held by a holding unit configured to hold a movement estimation rule corresponding to a partial region specified in the video, determining whether a region where the person has disappeared from the video or appeared in the video corresponds to the partial region; and estimating, based on the movement estimation rule corresponding to the partial region determined to correspond, a movement of the person after the person has disappeared from the video or before the person has appeared in the video.

Further features of the present invention will be apparent from the following description of exemplary embodiments with reference to the attached drawings.

### BRIEF DESCRIPTION OF THE DRAWINGS

FIG. 1 is a view showing an example of a monitoring target region according to the first embodiment;

FIG. 2 is a block diagram showing an example of the functional arrangement of an information processing apparatus 10 according to the first embodiment;

FIG. 3 is a view showing an example of a video captured by a camera 11;

FIG. 4 is a view showing examples of areas according to the first embodiment;

FIG. 5 is a flowchart illustrating an example of the processing procedure of the information processing apparatus 10 shown in FIG. 2;

FIGS. 6A and 6B are views showing examples of monitoring target regions according to the second embodiment;

FIG. 7 is a block diagram showing an example of the functional arrangement of an information processing apparatus 10 according to the second embodiment;

FIGS. 8A and 8B are views showing examples of videos captured by a camera 21; and

FIGS. 9A and 9B are views showing examples of areas according to the second embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

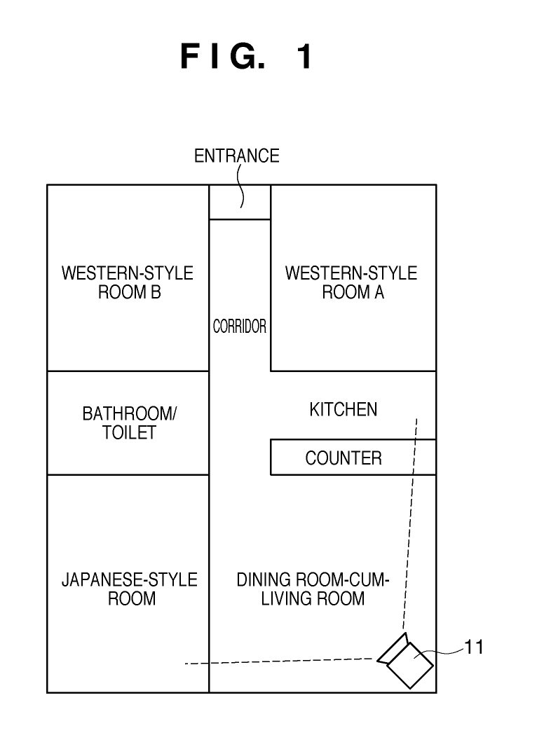

The monitoring target of an information processing apparatus according to this embodiment will be described first. FIG. 1 shows an example of a monitoring target region according to the first embodiment. In this case, the floor plan of a three-bedroom condominium with a living room plus kitchen is shown as a monitoring target region.

The dining room-cum-living room and a Japanese-style room are arranged south (on the lower side of FIG. 1). A counter-kitchen is provided to the north (on the upper side of FIG. 1) of the dining room-cum-living room. A Western-style room A is arranged on the other side of the wall of the kitchen. A bathroom/toilet exists on the north (on the upper side of FIG. 1) of the Japanese-style room. A Western-style room B is provided on the other side of the wall of the bathroom/toilet. A corridor runs between the dining room-cum-living room and Western-style room A and the Japanese-style room, bathroom/toilet, and Western-style room B. The entrance is laid out to the north (on the upper side of FIG. 1) of the corridor.

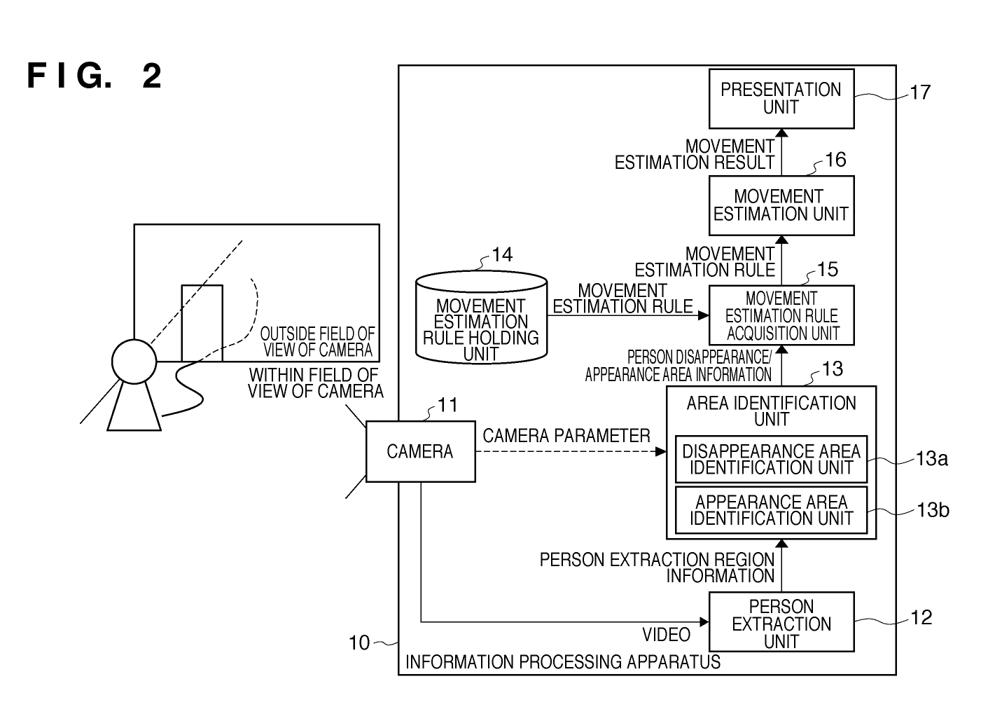

FIG. 2 is a block diagram showing an example of the functional arrangement of an information processing apparatus 10 according to the first embodiment.

The information processing apparatus 10 includes a camera 11, person extraction unit 12, area identification unit 13, movement estimation rule holding unit 14, movement estimation rule acquisition unit 15, movement estimation unit 16, and presentation unit 17.

The camera 11 functions as an image capturing apparatus, and captures the real space. The camera 11 can be provided either outside or inside the information processing apparatus 10. In the first embodiment, providing the camera 11 outside the apparatus (at a corner of the living room (on the lower right side of FIG. 1)) will be exemplified. The camera 11 provided outside the apparatus is, for example, suspended from the ceiling or set on the floor, a table, or a TV. The camera 11 may be incorporated in an electrical appliance such as a TV. In the first embodiment, the camera 11 captures a scene as shown in FIG. 3, that is, a video mainly having the dining room-cum-living room in its field of view. The video also includes a sliding door of the Japanese-style room on the left side, the kitchen on the right side, the door of the bathroom/toilet a little to the right on the far side (on the upper side of FIG. 1), and the corridor to the two Western-style rooms and the entrance to its right. Note that the parameters (camera parameters) of the camera 11 such as a pan/tilt and zoom can be either fixed or variable. If the camera parameters are fixed, the information processing apparatus 10 (more specifically, the area identification unit 13) holds parameters measured in advance (the parameters may be held in another place the area identification unit 13 can refer to). Note that if the camera parameters are variable, the variable values are measured by the camera 11.

The person extraction unit 12 receives a video from the camera 11, and detects and extracts a region including a person. Information about the extracted region (to be referred to as a person extraction region information hereinafter) is output to the area identification unit 13. Note that the person extraction region information is, for example, a group of coordinate information or a set of representative coordinates and shape information. Note that the region is extracted using a conventional technique, and the method is not particularly limited. For example, a method disclosed in U.S. Patent Application Publication No. 2007/0237387 is used.

The person extraction unit 12 may have a person recognition function, clothes recognition function, orientation recognition function, action recognition function, and the like. In this case, the person extraction unit 12 may recognize who is the person extracted from the video, what kind of person he/she is (male/female and age), his/her clothes, orientation, action, and movement, an article he/she holds in hand, and the like. If the person extraction unit 12 has such functions, it outputs the feature recognition result of the extracted person to the area identification unit 13 as well as the person extraction region information.

The area identification unit 13 identifies, from a partial region (to be referred to as an area hereinafter) of the video, an area where a person has disappeared (person disappearance area) or an area where a person has appeared (person appearance area). More specifically, the area identification unit 13 includes a disappearance area identification unit 13a and an appearance area identification unit 13b. The disappearance area identification unit 13a identifies the above-described person disappearance area. The appearance area identification unit 13b identifies the above-described person appearance area. The area identification unit 13 performs the identification processing by holding a person extraction region information reception history (a list of person extraction region information reception times) and referring to it.

After the identification of the area (person disappearance area or person appearance area), the area identification unit 13 outputs information including information representing the area and the time of area identification to the movement estimation rule acquisition unit 15 as person disappearance area information or person appearance area information.

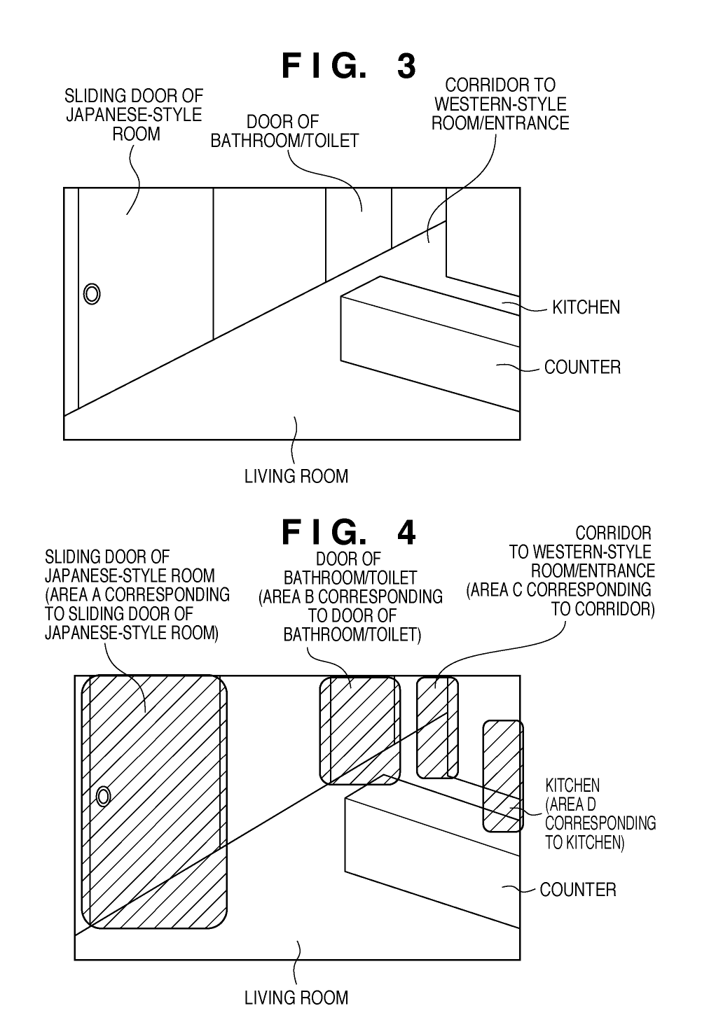

The above-described area indicates, for example, a partial region in a video captured by the camera 11, as shown in FIG. 4. One or a plurality of areas (a plurality of areas in this embodiment) are set in advance, as shown in FIG. 4. An area of the video including the door of the bathroom/toilet and its vicinity is associated with the door of the bathroom/toilet in the real space. Each area of the video is associated with the real space using, for example, the camera parameters of the camera 11. The association is done using a conventional technique, and the method is not particularly limited. For example, a method disclosed in Kouichiro Deguchi, “Fundamentals of Robot Vision”, Corona Publishing, 2000 is used. Note that when the camera parameters change, the areas in the video move or deform, as a matter of course. All regions in the video may be defined as areas of some kinds, or only regions where a person can disappear (go out of the video) or appear (start being captured in the video) may be provided as areas.

When the area identification unit 13 (disappearance area identification unit 13a) continuously receives person extraction region information for a predetermined time or more, and reception of the information stops, the area represented by the lastly received person extraction region information is identified as a person disappearance area. When the area identification unit 13 (appearance area identification unit 13b) receives person extraction region information after not receiving person extraction region information continuously for a predetermined time or more, the area represented by the received person extraction region information is identified as a person appearance area.

The movement estimation rule holding unit 14 holds a movement estimation rule corresponding to each area. For example, for the area arrangement shown in FIG. 4, the movement estimation rule holding unit 14 holds a movement estimation rule for an area A corresponding to the sliding door of the Japanese-style room, a movement estimation rule for an area B corresponding to the door of the bathroom/toilet, a movement estimation rule for an area C corresponding to the corridor, and a movement estimation rule for an area D corresponding to the kitchen. Note that if person extraction region information includes a feature recognition result, the movement estimation rule holding unit 14 holds the movement estimation rule for each area corresponding to each feature recognition result (for example, each person).

The movement estimation rule is a list that associates, for example, at least one piece of condition information out of a movement estimation time, person disappearance time, person appearance time, and reappearance time with movement estimation result information representing a movement estimation result corresponding to the condition information. The movement estimation rule may be a function which has at least one of the pieces of condition information as a variable and calculates a movement estimation result corresponding to it. Note that the movement estimation time is a time the movement is estimated. The person disappearance time is a time a person has disappeared. The person appearance time is a time a person has appeared. The reappearance time is time information representing a time from person disappearance to reappearance.

The movement estimation rule acquisition unit 15 receives person disappearance area information or person appearance time information from the area identification unit 13, and acquires, from the movement estimation rule holding unit 14, a movement estimation rule corresponding to the person disappearance area or person appearance area represented by the received information. The acquired movement estimation rule is output to the movement estimation unit 16. Note that if the person disappearance area information or person appearance area information includes a feature recognition result, the movement estimation rule acquisition unit 15 acquires a movement estimation rule based on the feature recognition result and the person disappearance area or person appearance area, and outputs it to the movement estimation unit 16. For example, a movement estimation rule corresponding to each resident or movement estimation rules for a case in which the clothes at the time of disappearance and those at the time of appearance are the same and a case in which the clothes are different are prepared. Additionally, for example, a movement estimation rule is prepared for each orientation or each action of a person at the time of person disappearance (more exactly, immediately before disappearance).

Upon receiving the movement estimation rule from the movement estimation rule acquisition unit 15, the movement estimation unit 16 estimates the movement of a person after he/she has disappeared from the video or the movement of a person before his/her appearance using the movement estimation rule. That is, the movement estimation unit 16 estimates the movement of a person outside the image capturing region (in an uncaptured region). Note that when estimating the movement after person disappearance, the movement estimation unit 16 sequentially performs the estimation until the person appears. The movement estimation result is output to the presentation unit 17.

Upon receiving the movement estimation result from the movement estimation unit 16, the presentation unit 17 records the movement estimation result as data, and presents it to the user. The presentation unit 17 also manipulates the data, as needed, before presentation. An example of data manipulation is recording data of a set of a movement estimation result and an estimation time in a recording medium and presenting a list of data arranged in time series on a screen or the like. However, the present invention is not limited to this. A summary of movement recording data is presented to a resident or a family member living in a separate house as so-called life log data, or presented to a health worker or care worker who is taking care of a resident as health medical data. The person who has received the information reconsiders the life habit or checks symptoms of a disease or health condition at that time. Note that the information processing apparatus 10 itself may automatically recognize some kind of symptom from the movement recording data, select or generate information, and present it to a person.

An example of the functional arrangement of the information processing apparatus 10 has been described above. Note that the information processing apparatus 10 incorporates a computer. The computer includes a main control unit such as a CPU, and a storage unit such as a ROM (Read Only Memory), RAM (Random Access Memory), and HDD (Hard Disk Drive). The computer also includes an input/output unit such as a keyboard, mouse, display, buttons, and touch panel. These components are connected via a bus or the like, and controlled by causing the main control unit to execute programs stored in the storage unit.

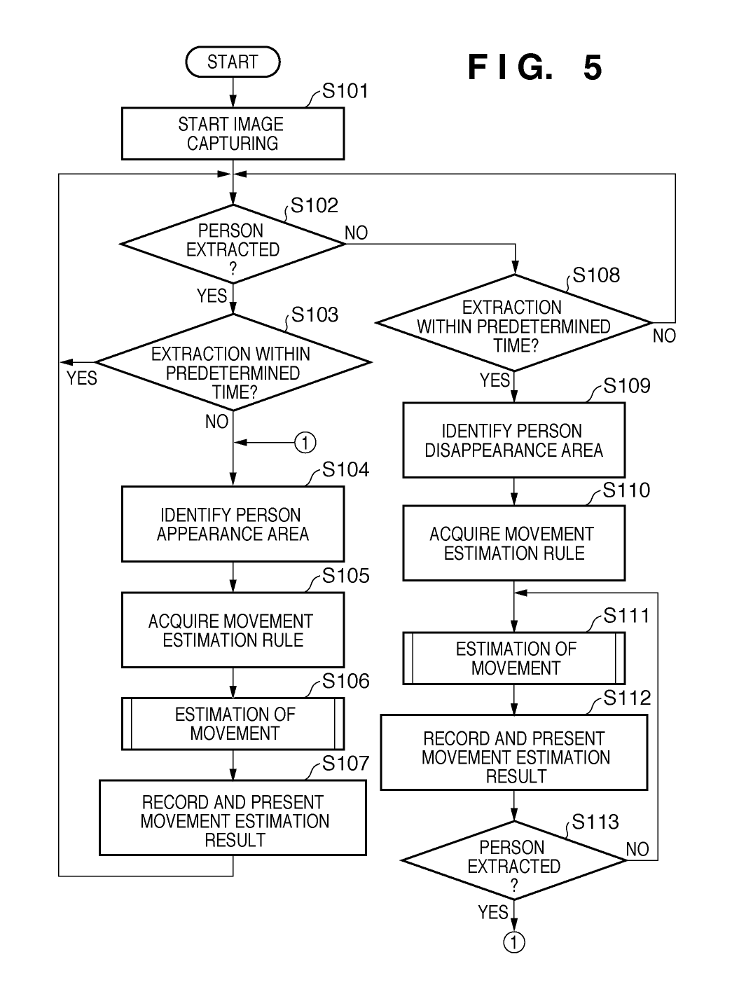

An example of the processing procedure of the information processing apparatus 10 shown in FIG. 2 will be explained next with reference to FIG. 5.

In this processing, first, the camera 11 starts capturing the real space (S101). The information processing apparatus 10 causes the person extraction unit 12 to detect and extract a region including a person from the video.

If no region including a person is detected (NO in step S102), the information processing apparatus 10 causes the area identification unit 13 to determine whether a person has been extracted within a predetermined time (for example, 3 sec) (from the current point of time to a point before a predetermined time). This determination is done based on whether person extraction region information has been received from the person extraction unit 12 within the time.

If no person has been extracted within the predetermined time (NO in step S108), it means that no person is continuously included in the video. Hence, the information processing apparatus 10 returns to the process in step S102. If a person has been extracted within the predetermined time (YES in step S108), it means that a person has disappeared from the video during the time from the point before a predetermined time to the current point of time. In this case, the information processing apparatus 10 causes the area identification unit 13 to identify the person disappearance area (S109). More specifically, the area identification unit 13 specifies which area includes the region represented by the lastly received person extraction region information by referring to the record in the area identification unit 13, and identifies the area as the person disappearance area. Information representing the area and the lastly received person extraction region information (the person extraction region information of the latest time corresponding to the person disappearance time) are output to the movement estimation rule acquisition unit 15 as person disappearance area information.

Next, the information processing apparatus 10 causes the movement estimation rule acquisition unit 15 to acquire a movement estimation rule corresponding to the person disappearance area from the movement estimation rule holding unit 14 (S110). This acquisition is performed based on the person disappearance area information from the area identification unit 13.

When the movement estimation rule is acquired, the information processing apparatus 10 causes the movement estimation unit 16 to estimate, based on the movement estimation rule, the movement of the person after he/she has disappeared from the video (S111). The movement estimation is performed using, for example, the movement estimation time, person disappearance time, the elapsed time from disappearance, or the like (the feature recognition result of the disappeared person in some cases), as described above.

After movement estimation, the information processing apparatus 10 causes the presentation unit 17 to record the movement estimation result from the movement estimation unit 16 and present it (S112). After that, the information processing apparatus 10 causes the person extraction unit 12 to perform the detection and extraction processing as described above. As a result, if no region including a person is detected (NO in step S113), the process returns to step S111 to estimate the movement. That is, the movement of the person after disappearance is continuously estimated until the disappeared person appears again. Note that if a region including a person is detected in the process of step S113 (YES in step S113), the information processing apparatus 10 advances the process to step S104. That is, processing for person appearance is executed.

If a region including a person is detected in step S102 (YES in step S102), the person extraction unit 12 sends person extraction region information to the area identification unit 13. Upon receiving the information, the area identification unit 13 determines whether a person has been extracted within a predetermined time (for example, 3 sec) (from the point of time the information has been received to a point before a predetermined time). This determination is done based on whether person extraction region information has been received from the person extraction unit 12 within the time.

If a person has been extracted within the predetermined time (YES in step S103), it means that the person is continuously included in the video. Hence, the information processing apparatus 10 returns to the process in step S102. If no person has been extracted within the predetermined time (NO in step S103), the area identification unit 13 interprets it as person appearance in the video, and performs processing for person appearance.

At the time of person appearance, the information processing apparatus 10 causes the area identification unit 13 to identify the person appearance area (S104). More specifically, the area identification unit 13 specifies which area includes the region represented by the person extraction region information by referring to the record in the area identification unit 13, and identifies the area as the person appearance area. Information representing the area and the lastly received person extraction region information (the person extraction region information of the latest time corresponding to the person appearance time) are output to the movement estimation rule acquisition unit 15 as person appearance area information. Note that if present, person extraction region information (corresponding to the person disappearance time) immediately before the lastly received person extraction region information is also output to the movement estimation rule acquisition unit 15 as person appearance area information.

Next, the information processing apparatus 10 causes the movement estimation rule acquisition unit 15 to acquire a movement estimation rule corresponding to the person appearance area from the movement estimation rule holding unit 14 (S105). This acquisition is performed based on the person appearance area information from the area identification unit 13.

When the movement estimation rule is acquired, the information processing apparatus 10 causes the movement estimation unit 16 to estimate, based on the movement estimation rule, the movement of the person before he/she has appeared in the video (S116).

After movement estimation, the information processing apparatus 10 causes the presentation unit 17 to record the movement estimation result from the movement estimation unit 16 and present it (S117). After that, the information processing apparatus 10 returns to the process in step S102.

An example of the processing procedure of the information processing apparatus 10 has been described above. Note that if the person extraction unit 12 has a person recognition function, clothes recognition function, or the like, the feature recognition result of the extracted person is also output to the area identification unit 13 in addition to the person extraction region information in step S102. At this time, for example, only when a person identical to the extracted person has been extracted, the person extraction unit 12 outputs person extraction region information to the area identification unit 13. In step S105 or S110, the movement estimation rule acquisition unit 15 acquires a movement estimation rule based on the feature recognition result and the person disappearance area information or appearance area information. In step S106 or S111, the movement estimation unit 16 estimates the movement of the person after disappearance or before appearance in the video based on the acquired movement estimation rule.

The movement estimation method (at the time of person disappearance) in step S111 of FIG. 5 will be described using detailed examples.

For example, assume that the area A corresponding to the sliding door of the Japanese-style room in FIG. 4 is the person disappearance area, the person disappearance time is between 21:00 and 6:00, and the disappeared person yawned before disappearance. In this case, the movement estimation unit 16 estimates that “(the disappeared person) is sleeping in the Japanese-style room”. For example, if the area B corresponding to the door of the bathroom/toilet in FIG. 4 is the person disappearance area, and the movement estimation time is 5 min after the person disappearance time, the movement estimation unit 16 estimates that “(the disappeared person) is in the toilet”. When the time has further elapsed, the movement estimation time is 10 min after the person disappearance time, and the person disappearance time is between 18:00 and 24:00, the movement estimation unit 16 estimates that “(the disappeared person) is taking a bath”.

For example, similarly, if the area B is the person disappearance area, the person disappearance time is before 18:00, and the disappeared person had scrubbing things, the movement estimation unit 16 estimates that “(the disappeared person) is cleaning the toilet or bathroom”. For example, similarly, if the area B is the person disappearance area, and the movement estimation time is 60 min after the person disappearance time, the movement estimation unit 16 estimates that “(the disappeared person) may suffer in the toilet or bathroom”. For example, if the area C corresponding to the corridor in FIG. 4 is the person disappearance area, and the movement estimation time is 30 min after the person disappearance time, the movement estimation unit 16 estimates that “(the disappeared person) is going out”. For example, if the area D corresponding to the kitchen in FIG. 4 is the person disappearance area, the movement estimation time is near 17:00, and the disappeared person is in charge of household chores, the movement estimation unit 16 estimates that “(the disappeared person) is making supper”.

The movement estimation method (at the time of person appearance) in step S106 of FIG. 5 will be described using detailed examples.

For example, if the area A corresponding to the sliding door of the Japanese-style room in FIG. 4 is the person appearance area, and the person appearance time is between 6:00 and 8:00, the movement estimation unit 16 estimates that “(the appeared person) has gotten up in the Japanese-style room” (and then appeared in the living room). For example, if the area B corresponding to the door of the bathroom/toilet in FIG. 4 is the person appearance area, and the time between the person disappearance time and the person appearance time is 5 min, the movement estimation unit 16 estimates that “(the appeared person) was in the toilet”. If the time between the person disappearance time and the person appearance time is 30 min, the person disappearance time is between 18:00 and 24:00, and the clothes after the disappearance are different from those before the disappearance, the movement estimation unit 16 estimates that “(the appeared person) was taking a bath”. Similarly, if the time between the person disappearance time and the person appearance time is 30 min, the person disappearance time is before 18:00, and the clothes after the disappearance are the same as those before the disappearance, the movement estimation unit 16 estimates that “(the appeared person) was cleaning the toilet or bathroom”. For example, if the area C corresponding to the corridor in FIG. 4 is the person appearance area, and the time between the person disappearance time and the person appearance time is 30 min, the movement estimation unit 16 estimates that “(the appeared person) was doing something in the Western-style room A or B”. If the time between the person disappearance time and the person appearance time is several hours, and the person appearance time is after 17:00, the movement estimation unit 16 estimates that “(the appeared person) has come home”. For example, if the area D corresponding to the kitchen in FIG. 4 is the person appearance area, and the time between the person disappearance time and the person appearance time is 1 min, the movement estimation unit 16 estimates that “(the appeared person) has fetched something from the refrigerator in the kitchen”.

As described above, according to the first embodiment, it is possible to estimate the movement of a person in an uncaptured region. Since this allows to, for example, decrease the number of cameras, the cost can be reduced.

More specifically, according to the first embodiment, a movement in the range included in a video is recorded as a video like before. A movement in the range outside the video is qualitatively estimated after specifying the place where the target person exists, and recorded as data. The person existence place is specified based on the area where the person has disappeared or appeared in the video. When this technique is applied to, for example, a common home, places where a person can exist after disappearance or before appearance are limited. Hence, the movement of a person after disappearance or before appearance can be estimated by installing one camera in, for example, a living room that is usually located at the center of the house.

In addition, the number of types of movements that can occur at many places in a common home is relatively small. Hence, if the places (monitoring target regions) are specified (or limited), the movement of a person can accurately be estimated using even a few cameras. Note that even in the range included in the video, an object or the like may hide a person so his/her movement there cannot be recorded as a video. In this case as well, the arrangement of the first embodiment is effective.

### Second Embodiment

The second embodiment will be described next. In the second embodiment, an example will be explained in which the movement of a person in a common home is, for example, estimated using a plurality of cameras whose fields of view do not overlap, sensors near the cameras, and sensors far apart from the cameras.

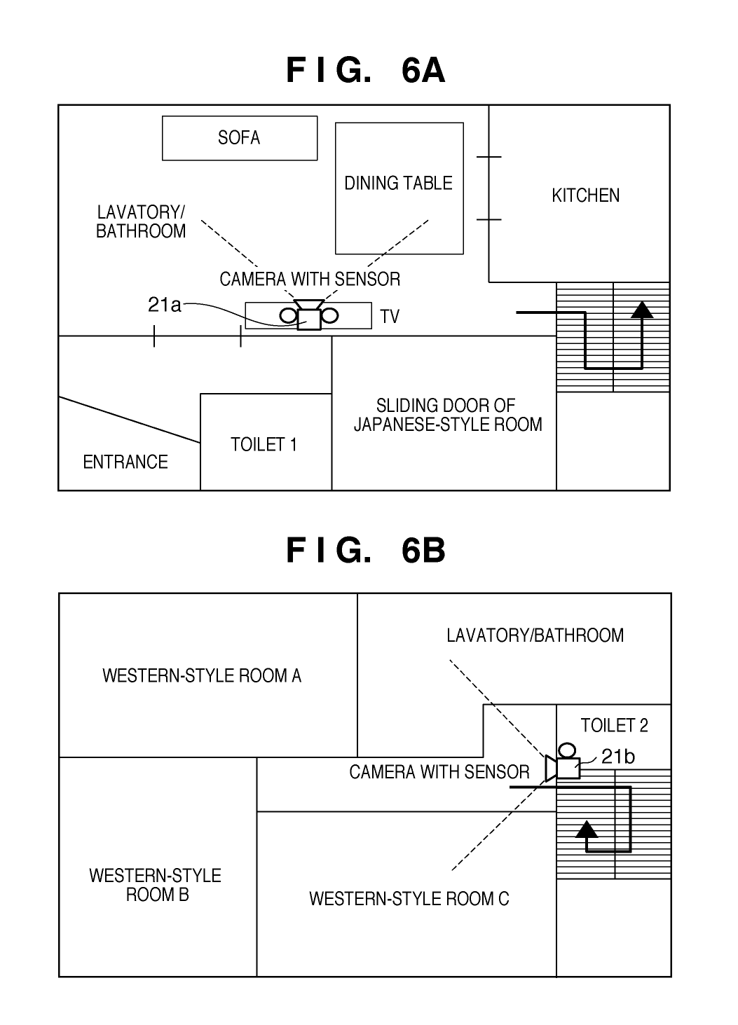

FIGS. 6A and 6B show examples of monitoring target regions according to the second embodiment. In this case, the floor plans of a two-story house having four bedrooms and a living room plus kitchen are shown as monitoring target regions. FIG. 6A shows the floor plan of the first floor. FIG. 6B shows the floor plan of the second floor. The floor plan of the first floor shown in FIG. 6A includes a dining room-cum-living room furnished with a sofa and a dining table, Japanese-style room, kitchen, toilet 1, entrance, and stairs to the second floor. The floor plan of the second floor shown in FIG. 6B includes the stairs from the first floor, Western-style room A, Western-style room B, Western-style room C, lavatory/bathroom, and toilet 2.

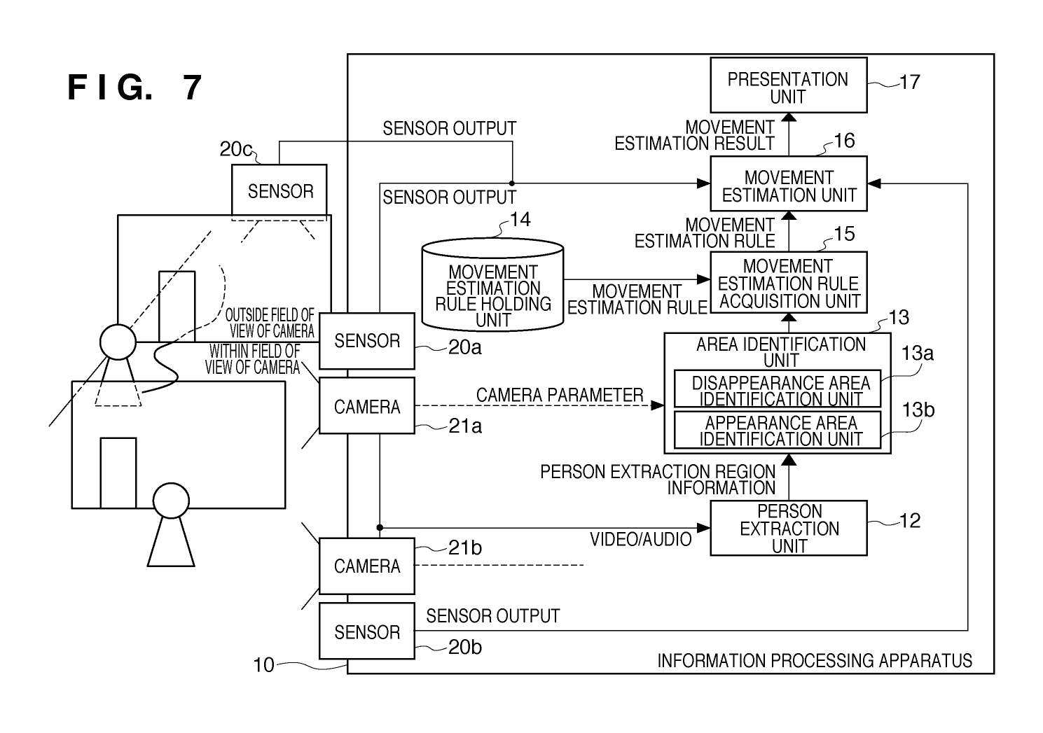

FIG. 7 is a block diagram showing an example of the functional arrangement of an information processing apparatus 10 according to the second embodiment. Note that the same reference numerals as in FIG. 2 explained in the first embodiment denote parts with the same functions in FIG. 7, and a description thereof will not be repeated. In the second embodiment, differences from the first embodiment will mainly be described.

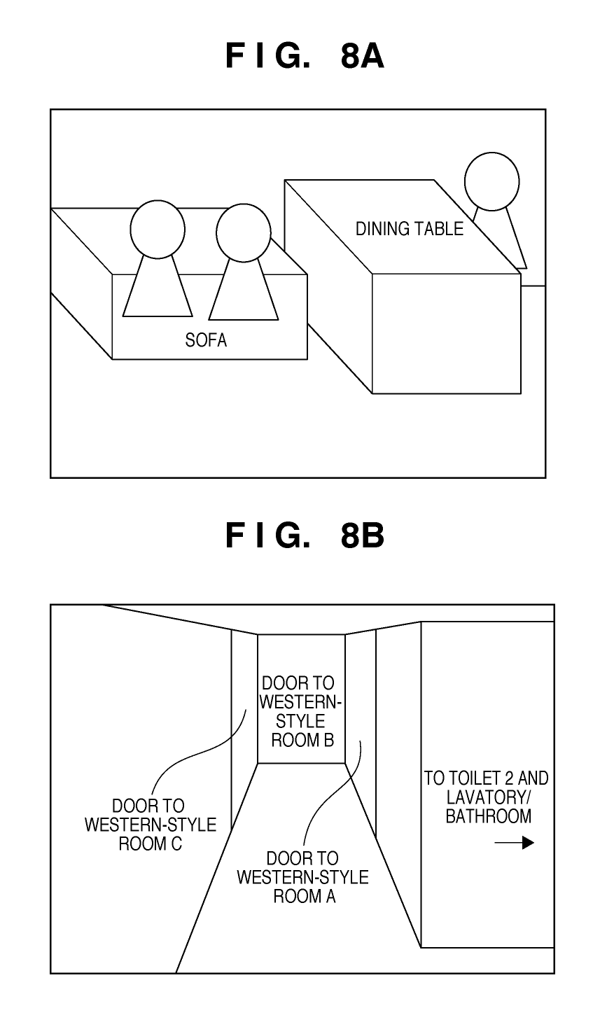

The information processing apparatus 10 newly includes a plurality of cameras 21 (21a and 21b) and a plurality of sensors 20 (20a to 20c). The cameras 21 capture the real space, as in the first embodiment. The camera 21a is installed on the first floor shown in FIG. 6A and, more particularly, on the TV near the wall on the south (on the lower side of FIG. 6A) of the living room. In this case, a video as shown in FIG. 8A is captured. That is, the camera 21a captures the family in the house having a meal or unbending. However, the camera 21a cannot capture the states of places other than the dining room-cum-living room, that is, the Japanese-style room, kitchen, toilet 1, entrance, and stairs to the second floor. The camera 21b is installed on the second floor shown in FIG. 6B and, more particularly, on the ceiling at the head of the stairs. In this case, a video as shown in FIG. 8B is captured. That is, the camera 21b captures the doors of the Western-style rooms A, B, and C, and the short corridor to the toilet 2 and lavatory/bathroom.

A person extraction unit 12 receives videos from the cameras 21a and 21b, and detects and extracts a region including a person. Note that person extraction region information according to the second embodiment includes camera identification information representing which camera 21 has captured the video.

A movement estimation rule holding unit 14 holds a movement estimation rule corresponding to each area. The movement estimation rule according to the second embodiment holds not only the condition information described in the first embodiment but also the output values of the sensors 20 (20a to 20c) as condition information. For example, the condition information is held for each output value of the sensors 20 (20a to 20c). The movement estimation rule may be a function which has at least one of the pieces of condition information including the sensor output values as a variable and calculates a movement estimation result corresponding to it, as a matter of course.

A movement estimation unit 16 estimates the movement of a person after he/she has disappeared from the video captured by the camera 21a or 21b, or the movement of a person before his/her appearance. The estimation is performed based on the contents of the movement estimation rule from a movement estimation rule acquisition unit 15 and, as needed, using the sensor outputs from the sensors 20 (20a to 20c).

The sensors 20 (20a to 20c) measure or detect a phenomenon (for example, audio) in the real space. The sensors 20 have a function of measuring the state of the real space outside the fields of view of the cameras. For example, each sensor is formed from a microphone, and measures sound generated by an event that occurs outside the field of view of the camera. If two microphones each having directivity are used, one microphone may selectively measure sound of an event that occurs in the real space on the right outside the field of view of the camera, and the other may selectively measure sound of an event that occurs in the real space on the left outside the field of view of the camera. The real space state to be measured need not always be outside the field of view of the camera and may be within it, as a matter of course. In the second embodiment, the sensors 20a and 20b are provided in correspondence with the cameras 21a and 21b, respectively. The sensor 20a includes two microphones each having directivity. The sensor 20b includes one microphone without directivity. The sensor 20c is installed far apart from the cameras 21a and 21b. The sensor 20c detects, for example, ON/OFF of electrical appliances and electric lights placed in the real space outside the fields of view of the cameras 21a and 21b. Note that the sensors 20 may be, for example, motion sensors for detecting the presence of a person. The plurality of sensors may exist independently in a plurality of places.

Note that the processing procedure of the information processing apparatus 10 according to the second embodiment is basically the same as in FIG. 5 described in the first embodiment, and a detailed description thereof will be omitted. Only differences will briefly be explained. Upon detecting a person, the person extraction unit 12 outputs person extraction region information including the above-described camera identification information to an area identification unit 13. The area identification unit 13 identifies a person disappearance area or person appearance area. This identification processing is performed in consideration of the camera identification information. More specifically, a person disappearance area or person appearance area is identified using videos having the same camera identification information. The movement estimation unit 16 performs movement estimation using the sensor outputs from the sensors 20, as needed, in addition to the information used in the first embodiment. Movement estimation processing according to the second embodiment is thus executed.

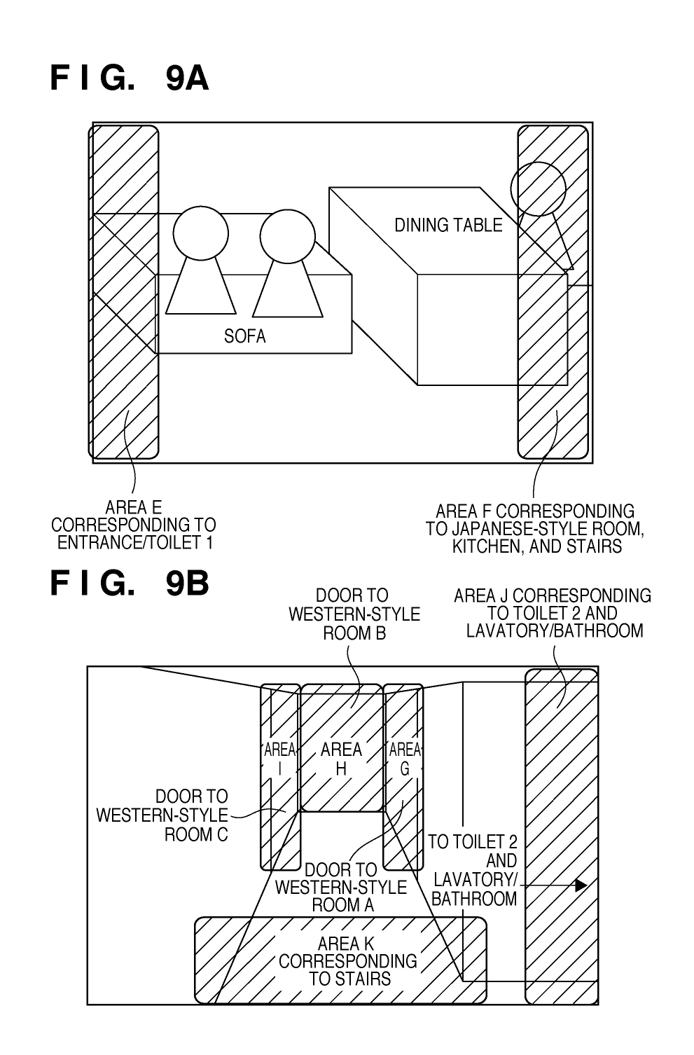

The movement estimation method (at the time of person disappearance) according to the second embodiment will be described using detailed examples with reference to FIGS. 9A and 9B. Note that FIG. 9A shows an example of a video captured by the camera 21a, and FIG. 9B shows an example of a video captured by the camera 21b.

For example, if an area E corresponding to toilet 1 in FIG. 9A is the person disappearance area, and the microphone (sensor 20a) oriented toward the area has recorded the sound of the interior door opening/closing, the movement estimation unit 16 estimates that “(the disappeared person) has entered the toilet”. If the microphone (sensor 20a) oriented toward the area E has recorded the sound of the exterior door opening/closing and the sound of locking the door, the movement estimation unit 16 estimates that “(the disappeared person) has gone out”. Alternatively, if an area F in FIG. 9A is the person disappearance area, and the microphone (sensor 20a) oriented toward the area F has recorded the sound of water, the movement estimation unit 16 estimates that “(the disappeared person) is doing washing in the kitchen”. For example, if it is determined based on the output of the sensor 20c that the coffee maker placed in the kitchen was switched on, the movement estimation unit 16 estimates that “(the disappeared person) is making coffee in the kitchen”. For example, if the microphone (sensor 20a) oriented toward the area F has recorded the sound of the sliding door opening/closing, the movement estimation unit 16 estimates that “(the disappeared person) has entered the Japanese-style room”. For example, if the microphone (sensor 20a) oriented toward the area F has recorded the sound of a person going up the stairs, the movement estimation unit 16 estimates that “(the disappeared person) has gone upstairs”.

For example, if an area G/H/I in FIG. 9B is the person disappearance area, the person disappearance time is between 21:00 and 6:00, and the disappeared person mainly uses the Western-style room A/B/C, the movement estimation unit 16 estimates that “(the disappeared person) has gone to bed in his/her own room”. Alternatively, for example, assume that the area G/H/I in FIG. 9B is the person disappearance area, the person disappearance time is between 0:00 and 6:00, the disappeared person is not the person who mainly uses the Western-style room A/B/C, and the sensor 20b corresponding to the camera 21b has recorded coughing. In this case, the movement estimation unit 16 estimates that “(the disappeared person) has gone to see the person in the Western-style room A/B/C, concerned about his/her condition”. For example, if an area J corresponding to toilet 2 and lavatory/bathroom in FIG. 9B is the person disappearance area, and it is determined based on the output of the sensor 20c that the light of the washstand was switched on, the movement estimation unit 16 estimates that “(the disappeared person) is using the washstand”. For example, if the sensor 20b has recorded the sound of the sliding door of the bathroom closing, the movement estimation unit 16 estimates that “(the disappeared person) has entered the bathroom”. For example, if the sensor 20b has recorded the sound of the door of toilet 2 closing, the movement estimation unit 16 estimates that “(the disappeared person) has entered the toilet”. For example, if an area K corresponding to the stairs in FIG. 9B is the person disappearance area, the movement estimation unit 16 estimates that “(the disappeared person) has gone downstairs”.

The movement estimation method (at the time of person appearance) according to the second embodiment will be described next using detailed examples.

For example, if the area E corresponding to the entrance and toilet 1 in FIG. 9A is the person appearance area, and the time between the person disappearance time and the person appearance time is 5 min, the movement estimation unit 16 estimates that “(the appeared person) was in the toilet”. For example, if the time between the person disappearance time and the person appearance time is 30 min, the movement estimation unit 16 estimates that “(the appeared person) was strolling in the neighborhood”. Alternatively, for example, assume that the area F corresponding to the Japanese-style room, kitchen, and stairs in FIG. 9A is the person disappearance area, and the area K corresponding to the stairs in FIG. 9B is the person appearance area. Also assume that the microphone (sensor 20a) oriented toward the area F has recorded the sound of a cleaner between the person disappearance and appearance, and the time between the person disappearance time and the person appearance time is 10 min. In this case, the movement estimation unit 16 estimates that “(the appeared person) was cleaning the stairs (instead of simply going upstairs)”.

As described above, according to the second embodiment, a plurality of cameras whose fields of view do not overlap, sensors provided in correspondence with the cameras, and sensors far apart from the cameras are used. This makes it possible to more specifically estimate the movement of a person after he/she has disappeared from a video or the movement of a person before he/she has appeared in a video. Since the number of cameras can be decreased as compared to arrangements other than that of the embodiment, the cost can be suppressed.

Note that in the second embodiment described above, two cameras are used. However, the number of cameras is not limited to this. In the second embodiment described above, the sensors include a microphone or a detection mechanism for detecting ON/OFF of electrical appliances. However, the types of sensor are not limited to those.

The condition information such as the person disappearance area, person appearance area, movement estimation time, person disappearance time, person appearance time, and reappearance time described in the first and second embodiments can freely be set and changed in accordance with the movement of the user or the indoor structure/layout. At the time of installation of the information processing apparatus 10, processing of optimizing the information may be performed based on the difference between actual movements and the record of the above-described movement estimation results. Note that the information may automatically be changed in accordance with the change in the age of a movement estimation target person, or automatic learning may be done using movement change results.

Examples of the typical embodiments of the present invention have been described above. The present invention is not limited to the above-described and illustrated embodiments, and various changes and modifications can be made within the spirit and scope of the present invention.

For example, the present invention can take an embodiment as, for example, a system, apparatus, method, program, or storage medium. More specifically, the present invention is applicable to a system including a plurality of devices or an apparatus including a single device.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-241879 filed on Oct. 20, 2009, which is hereby incorporated by reference herein in its entirety.

What is claimed is:

1. An information processing apparatus comprising:
an extraction unit configured to extract a person from a video obtained by capturing a real space;
a holding unit configured to hold a movement estimation rule corresponding to a partial region specified in the video;
a determination unit configured to determine whether a region where the person has disappeared from the video or appeared in the video corresponds to the partial region; and
an estimation unit configured to estimate, based on the movement estimation rule corresponding to the partial region determined to correspond, a movement of the person after the person has disappeared from the video or before the person has appeared in the video.

2. The apparatus according to claim 1, wherein the movement estimation rule includes, as a condition to estimate the movement of the person, at least one of a time the person has disappeared from the video, a time the person has appeared in the video, an elapsed time from the disappearance of the person from the video, and an elapsed time from the disappearance of the person from the video to reappearance.

3. The apparatus according to claim 1, wherein said extraction unit comprises a recognition unit configured to recognize a personal feature of the person.

4. The apparatus according to claim 3, wherein
said extraction unit extracts at least one person based on the recognized personal feature, and
said holding unit holds the movement estimation rule for each person.

5. The apparatus according to claim 3, wherein said estimation unit estimates, based on the personal feature when the person has disappeared and the personal feature when the person has reappeared, the movement of the person whose personal feature has been recognized.

6. The apparatus according to claim 1, further comprising a measurement unit configured to measure audio in the real space,
wherein the movement estimation rule includes the audio as a condition to estimate the movement of the person.

7. The apparatus according to claim 6, wherein the movement estimation rule includes audio after the person has disappeared from the video or before the person has appeared in the video as the condition to estimate the movement of the person.

8. The apparatus according to claim 1, wherein said holding unit holds at least one movement estimation rule corresponding to at least one partial region that exists in the video.

9. The apparatus according to claim 1, wherein said determination unit determines, based on a list of persons repeatedly extracted by said extraction unit, whether the region where the person has disappeared from the video or appeared in the video corresponds to the partial region.

10. The apparatus according to claim 1, further comprising an image capturing unit configured to capture a video of the real space.

11. The apparatus according to claim 1, further comprising a presentation unit configured to present the estimated movement of the person.

12. The apparatus according to claim 11, wherein said presentation unit presents, as life log data or health medical data of the person, a summary of movement history of the estimated movement of the person.

13. A processing method to be performed by an information processing apparatus, comprising:
extracting a person from a video obtained by capturing a real space;
based on information held by a holding unit configured to hold a movement estimation rule corresponding to a partial region specified in the video, determining whether a region where the person has disappeared from the video or appeared in the video corresponds to the partial region; and
estimating, based on the movement estimation rule corresponding to the partial region determined to correspond, a movement of the person after the person has disappeared from the video or before the person has appeared in the video.

14. A non-transitory computer-readable storage medium storing a program which causes a computer to execute steps of an information processing method of claim 13.
